(19) United States
(12) Patent Application Publication
(10) Pub. No.: US 2013/0060673 A1
(43) Pub. Date: Mar. 7, 2013

(54) Margin Requirement Determination for Variance Derivatives

(71) Applicants: Pavan Shah, Chicago, IL (US); Brent Skilton, Aurora, IL (US); Chad Voegele, Chicago, IL (US); Dale Michaels, Westmont, IL (US)

(72) Inventors: Pavan Shah, Chicago, IL (US); Brent Skilton, Aurora, IL (US); Chad Voegele, Chicago, IL (US); Dale Michaels, Westmont, IL (US)

(21) Appl. No.: 13/335,561

(22) Filed: Dec. 22, 2011

Related U.S. Application Data
(60) Provisional application No. 61/530,913, filed on Sep. 2, 2011.

(51) Int. Cl. G06Q 40/04

(52) U.S. Cl. 705/37

(57) ABSTRACT

A margin requirement determination for a financial product, a market price of which varies with volatility of a market value of an underlying instrument, includes determining a realized variance of the market value for each completed trading interval based on return data for the underlying instrument, calculating, for each completed trading interval, a respective implied variance of the financial product based on option trade data for the underlying instrument, computing a respective loss risk value for a corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval, and determining the margin requirement based on a subset of the loss risk values.

### CROSS-REFERENCE TO RELATED APPLICATION

This application claims the benefit of the filing date under 35 U.S.C. §119(e) of U.S. Provisional Application Ser. No. 61/530,913, filed Sep. 2, 2010, the entire disclosure of which is hereby incorporated by reference.

### TECHNICAL FIELD

The following disclosure relates to software, systems and methods for determining margin requirements in a commodities exchange, derivatives exchange or similar business.

### BACKGROUND

Futures Exchanges, referred to herein also as an “Exchange”, such as the Chicago Mercantile Exchange Inc. (CME), provide a marketplace where futures and options on futures are traded. Futures is a term used to designate all contracts covering the purchase and sale of financial instruments or physical commodities for future delivery on a commodity futures exchange. A futures contract is a legally binding agreement to buy or sell a commodity at a specified price at a predetermined future time. Each futures contract is standardized and specifies commodity, quality, quantity, delivery date and settlement. An option is the right, but not the obligation, to sell or buy the underlying instrument (in this case, a futures contract) at a specified price within a specified time. In particular, a put option is an option granting the right, but not the obligation, to sell a futures contract at the stated price prior to the expiration date. In contrast, a call option is an option contract which gives the buyer the right, but not the obligation, to purchase a specific futures contract at a fixed price (strike price) within a specified period of time as designated by the Exchange in its contract specifications. The buyer has the right to buy the commodity (underlying futures contract) or enter a long position, i.e., a position in which the trader has bought a futures contract that does not offset a previously established short position. A call writer (seller) has the obligation to sell the commodity (or enter a short position, i.e. the opposite of a long position) at a fixed price (strike price) during a certain fixed time when assigned to do so by the Clearing House. The term “short” refers to one who has sold a futures contract to establish a market position and who has not yet closed out this position through an offsetting procedure, i.e. the opposite of long. Generally, an offset refers to taking a second futures or options on futures position opposite to the initial or opening position, e.g. selling if one has bought, or buying if one has sold.

Typically, the Exchange provides a “clearing house” which is a division of the Exchange through which all trades made must be confirmed, matched and settled each day until offset or delivered. The clearing house is an adjunct to the Exchange responsible for settling trading accounts, clearing trades, collecting and maintaining performance bond funds, regulating delivery and reporting trading data. Clearing is the procedure through which the Clearing House becomes buyer to each seller of a futures contract, and seller to each buyer, and assumes responsibility for protecting buyers and sellers from financial loss by assuring performance on each contract. This is implemented through the clearing process, whereby transactions are matched. A clearing member is a firm qualified to clear trades through the Clearing House. A “member” of an Exchange is often a broker/trader registered with the Exchange.

While the disclosed embodiments will be described in reference to the CME, it will be appreciated that these embodiments are applicable to any Exchange, including those which trade in equities and other securities. The CME Clearing House clears, settles and guarantees all matched transactions in CME contracts occurring through its facilities. In addition, the CME Clearing House establishes and monitors financial requirements for clearing members and conveys certain clearing privileges in conjunction with the relevant exchange markets.

The Clearing House establishes clearing level performance bonds (margins) for all CME products and establishes minimum performance bond requirements for customers of CME products. A performance bond, also referred to as a margin, corresponds with the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit, which is required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

Options and futures may be based on more abstract market indicators, such as stock indices, interest rates, futures contracts and other derivatives. In these cases, cash settlement is employed. Using cash settlement, a holder of an index call option receives the right to “purchase” not the index itself, but rather a cash amount equal to the value of the index multiplied by a multiplier such as $100. Thus, if a holder of an index call option elects to exercise the option, the writer of the option is obligated to pay the holder the difference between the current value of the index and the strike price multiplied by the multiplier. However, the holder of the index will only realize a profit if the current value of the index is greater than the strike price. If the current value of the index is less than or equal to the strike price, the option is worthless due to the fact the holder would realize a loss.

Although futures contracts generally confer an obligation to deliver an underlying asset on a specified delivery date, the actual underlying asset need not ever change hands. Instead, futures contracts may be settled in cash such that to settle a future, the difference between a market price and a contract price is paid by one investor to the other. Again, like options, cash settlement allows futures contracts to be created based on more abstract “assets” such as market indices. Rather than requiring the delivery of a market index (a concept that has no real meaning), or delivery of the individual components that make up the index, at a set price on a given date, index futures can be settled in cash. In this case, the difference between the contract price and the price of the underlying asset (i.e., current value of market index) is exchanged between the investors to settle the contract.

A variance futures contract is an instrument that permits trading of variance risk, the risk that the squared volatility of the returns of the underlying financial product (e.g., S&P 500 index, oil, etc.) changes over time. In an S&P 500 12-month variance contract, the variance equals the sum of the squares of the daily changes of the index over the 12 months. Typically, the variance futures contract specifies a variance level (e.g., 1000 variance points), a contract multiplier (e.g., $50, such that the price of the contract is $50,000), and the settlement period during which the variance is accrued. Using those parameters, if traders A and B believe that the variance will be lower and higher, respectively, than 1000 during that period, trader A may sell one such futures contract to B for the contract price (e.g., $50,000). On the settlement date, if the accrued realized variance reached 1250, then trader A incurs a loss resulting in a payment to trader B of $12,500 ($62,500−$50,000). If the accrued realized variance only reached 750, then trader B incurs a loss of $12,500 ($50,000-$37,500) at the cash settlement. Trader A held the short position in this example (wanting relative low volatility), while trader B held the long position (wanting relative high volatility).

The margin requirements for variance futures are typically set at a multiple of the contract value. As a result, margins for variance futures are often unrealistically high and appear to traders as having no bearing on the market risk incurred by the exchange in connection with the derivatives.

### BRIEF DESCRIPTION OF THE DRAWINGS

FIG. 1 depicts a block diagram of an exemplary system for trading variance futures or other financial products according to the disclosed embodiments.

FIG. 2A is a block diagram of an exemplary system for determining a margin requirement in accordance with one embodiment.

FIG. 2B is a block diagram of another exemplary system for determining a margin requirement in accordance with one embodiment.

FIG. 3 is a flow chart diagram of an exemplary method for determining a margin requirement in accordance with one embodiment.

FIG. 4 shows an illustrative embodiment of a general computer system for use with the system of FIG. 1 and/or the system of FIG. 2 and/or for implementing the method of FIG. 3.

FIG. 5 is a graphical plot depicting a series of margin requirements resulting from implementing one example of the disclosed methods.

FIG. 6 is a graphical plot depicting another series of margin requirements resulting from implementing one example of the disclosed methods.

FIG. 7 is a graphical plot depicting yet another series of margin requirements resulting from implementing one example of the disclosed methods, as well as depicting changes in loss risk values (or profit and loss values) over time toward contract expiration.

FIGS. 8A-8C are graphical plots depicting margin requirements resulting from implementing one example of the disclosed methods for corn, wheat, and soybean variance futures contracts.

### DETAILED DESCRIPTION

The disclosed embodiments relate to determining margin requirements for derivative and other financial products whose market price varies with volatility of a market value of an underlying instrument. The disclosed margin determination methods may allow an Exchange or other entity to compute one-day margins at a coverage level of, for instance, 99% for variance futures with various underlying products such as equity index, corn, foreign currency exchange, silver, oil, etc. The disclosed methods accurately capture day-to-day risk present in such contracts. The disclosed methods and systems may allow an Exchange to reach a desired level of coverage or protection without being overly conservative.

The disclosed methods and systems of margining variance futures may be based on market data, namely options on futures contracts of various underlying products. The market data may be used to construct one or more time series or sequences of implied variance from which margins may be computed in dollars.

Variance is defined as a measure of dispersion as in statistics. In most cases, it is the variance of log-returns of levels over a time horizon (e.g., the life of the contract). The value of a variance future is essentially a sum of realized variance and implied variance. At any given point in time in the life of the contract, contributions toward the value of the contract come from both realized and implied variance. The realized variance corresponds with the variance experienced to date, e.g., the variance for each completed trading interval. The implied variance corresponds with, or is otherwise indicative of, an expected variance for any incomplete trading intervals. The implied variance may be considered a global implied variance, insofar as the expected variance is determined over all of the remaining (i.e., non-completed) trading intervals. If the contract is near the end of its life, then it is the realized variance that dominates implied variance. To margin these products, the disclosed methods address the day-to-day fluctuations in the price of these contracts. These fluctuations arise from the difference between realized variance and implied variance, and daily changes in implied variance. As described below, the disclosed methods may address these two processes involved in arriving at a margin amount.

In one aspect, the disclosed methods and systems utilize a variance futures margining methodology in which, for a financial product of interest (e.g., S&P Variance Futures), price or market levels are collected when a contract starts trading. For example, prices of call and put options on an underlying instrument or product (e.g., S&P 500) are collected for each date in which the price levels for the underlying instrument are collected. Such option price data may be collected over additional time periods, including, for instance, many dates in the past (e.g., before the contract starts trading). A global implied variance value (or fair variance strike K) may be inferred for each date as described below. Once a time series of actual price levels and global implied variance values has been constructed, the daily difference in the implied variance may be computed. To determine a margin requirement, a percentile (e.g., 99%) value may be selected from the set of computed differences. Other percentiles may be used and the look-back periods may vary. In alternative embodiments, the change in global implied variance may be modeled using a time series model such EWMA (exponentially weighted moving average) or GARCH(1,1) (generalized autoregressive conditional heteroskedasticity), as described below. The time series model may be used to forecast the implied variance one day ahead. The forecast data may, but need not, be used to scale the set of computed differences.

Although described below in connection with examples involving variance futures contracts, the methods described herein are well suited for determining margin requirements for a variety of variance derivatives or other financial products, now or hereafter developed, the market value of which is based on the volatility of an underlying financial product. Such derivatives or other financial products may include variance swaps. The parameters of the futures or other contract may vary from the examples shown. The disclosed methods and systems are not limited to any particular trading interval (e.g., day, hour, week, etc.), underlier, price interval, contract multiplier, settlement period, or other variance contract parameter.

The methods and systems described herein may integrated or otherwise combined with the risk management methods and systems described in the co-pending and commonly assigned U.S. patent application published as U.S. Patent Publication No. 2006/0265296 (“System and Method for Activity Based Margining”), the entire disclosure of which is incorporated by reference. For example, the methods and systems described herein may be configured as a component or module of the systems described in the above-referenced publication. Alternatively or additionally, the disclosed methods may generate data to be provided to the systems described in the above-referenced publication.

In one embodiment, the disclosed methods and systems are integrated or otherwise combined with the risk management system implemented by CME called Standard Portfolio Analysis of Risk™ (SPAM®). SPAN bases performance bond requirements on the overall risk of the portfolios using parameters as determined by CME's Board of Directors, and thus represents a significant improvement over other performance bond systems, most notably those that are “strategy-based” or “delta-based.” Further details regarding SPAN are set forth in the above-referenced application.

The embodiments are described in terms of a distributed computing system. The particular examples identify a specific set of components useful in a futures and options exchange. However, many of the components and inventive features are readily adapted to other electronic trading environments. The specific examples described herein may teach specific protocols and/or interfaces, although it should be understood that the principles involved are readily extended to other protocols and interfaces in a predictable fashion.

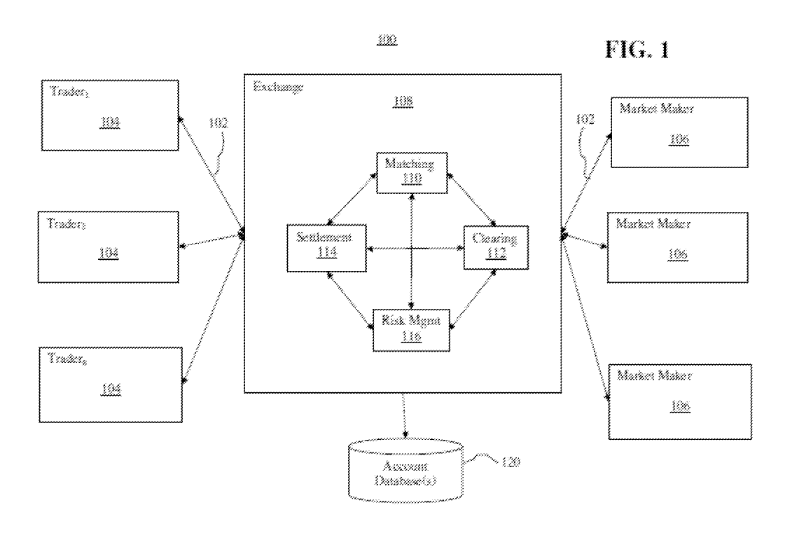

FIG. 1 shows a block diagram of an exemplary system 100 for trading financial products or instruments according to the disclosed embodiments. The system 100 is essentially a network 102 coupling market participants 104 and 106, including trader₁-traderₙ 104 and market makers 106 with the Exchange 108, such as the Chicago Mercantile Exchange. Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The Exchange 108 provides the functions of matching 110 buy/sell transactions, such as orders to buy or sell variance futures contracts, clearing 112 those transactions, settling 114 those transactions and managing risk 116 among the market participants 104 106 and between the market participants and the Exchange 108.

While the disclosed embodiments relate to the trading of variance futures contracts, the mechanisms and methods described herein are not limited thereto and may be applied to any financial product, the market price of which varies with volatility of an underlying financial product, e.g. any derivative financial product/instrument.

Typically, the Exchange 108 provides a “clearing house” which is a division of the Exchange 108 through which all trades made must be confirmed, matched and settled each day until offset or delivered. The clearing house is an adjunct to the Exchange 108 responsible for settling trading accounts, clearing trades, collecting and maintaining performance bond funds, regulating delivery and reporting trading data, essentially mitigating credit. Clearing is the procedure through which the Clearing House becomes buyer to each seller of, for example, a futures contract, and seller to each buyer, also referred to as a “novation,” and assumes responsibility for protecting buyers and sellers from financial loss by assuring performance on each contract. This is effected through the clearing process, whereby transactions are matched.

While the disclosed embodiments will be described in reference to the CME, it will be appreciated that these embodiments are applicable to any Exchange 108, including those which trade in equities and other securities. Such other Exchanges 108 may include a clearing house that, like the CME Clearing House, clears, settles and guarantees all matched transactions in contracts of the Exchange 108 occurring through its facilities. In addition, such clearing houses establish and monitor financial requirements for clearing members and conveys certain clearing privileges in conjunction with the relevant exchange markets.

As an intermediary, the Exchange 108 bears a certain amount of risk in each transaction that takes place. To that end, risk management mechanisms protect the Exchange 108 via the Clearing House. The Clearing House establishes clearing level performance bonds (margins) for all CME products and establishes minimum performance bond requirements for customers of CME products. A performance bond, also referred to as a margin, corresponds with the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit which is required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

The accounts of individual members, clearing firms and non-member customers doing business through CME are carried and guaranteed to the Clearing House by a clearing member. In every matched transaction executed through the Exchange's facilities, the Clearing House is substituted as the buyer to the seller and the seller to the buyer, with a clearing member assuming the opposite side of each transaction. The Clearing House is an operating division of the Exchange 108, and all rights, obligations and/or liabilities of the Clearing House are rights, obligations and/or liabilities of CME. Clearing members assume full financial and performance responsibility for all transactions executed through them and all positions they carry. The Clearing House, dealing exclusively with clearing members, holds each clearing member accountable for every position it carries regardless of whether the position is being carried for the account of an individual member, for the account of a non-member customer, or for the clearing member's own account. Conversely, as the contra-side to every position, the Clearing House is held accountable to the clearing members for the net settlement from all transactions on which it has been substituted as provided in the Rules.

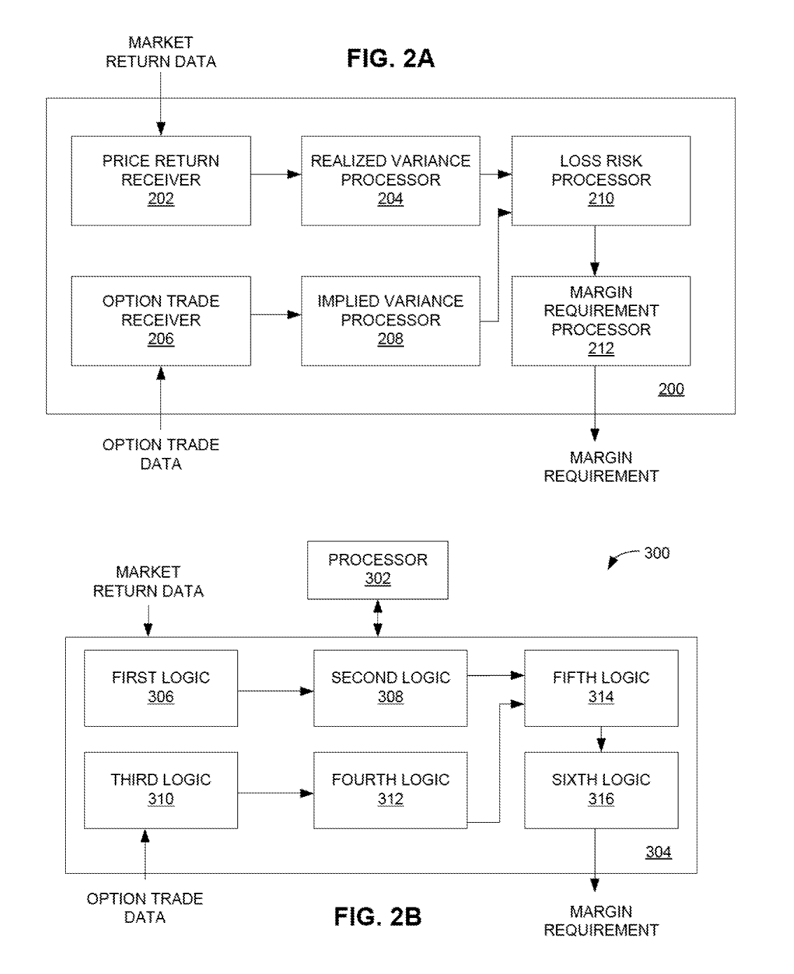

Referring to FIG. 2A, a system 200 is operative to determine a margin requirement for a financial product. The financial product is characterized by a risk of loss based on a market price that varies with volatility of a market value of an underlying instrument over a plurality of trading intervals. The system 200 includes a price return receiver 202 operative to receive, subsequent to completion of each trading interval, return data representative of the market value for the trading interval. The system 200 includes a realized variance processor 204 in communication with the price return receiver 202 and operative to determine a realized variance of the market value of the underlying instrument for each completed trading interval based on the return data. The system 200 includes an option trade receiver 206 operative to receive option trade data indicative of prices for one or more option contracts for the underlying instrument. The system 200 includes an implied variance processor 208 in communication with the option trade receiver 206 and operative to calculate, for each completed trade interval, a respective implied variance of the financial product based on the option trade data, the respective implied variance being indicative of an expected variance of the market value of the underlying instrument for any remaining incomplete trading intervals of the plurality of trade intervals. The system 200 includes a loss risk processor 210 in communication with the realized variance processor 204 and the implied variance processor 208, the loss risk processor 210 being operative to compute a respective loss risk value for each corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval. The system 200 includes a margin requirement processor 212 in communication with the loss risk processor 210 and operative to determine the margin requirement based on a subset of the loss risk values.

In some embodiments, the loss risk processor 210 may be configured to construct respective models of the first and second deviations over the completed trading intervals, determine first and second volatility forecasts for the first and second deviations based on the respective models, and scale each first deviation by the first volatility forecast and each second deviation by the second volatility forecast, respectively. The loss risk processor 210 may be further configured to divide each first and second deviation by a corresponding volatility predicted by the respective model for the corresponding trading interval. Alternatively or additionally, the loss risk processor 210 may be configured to simulate each respective loss risk value by summing the scaled first and second deviations for the corresponding trading interval. Alternatively or additionally, the loss risk processor 210 may be configured to fit the first and second deviations to a generalized autoregressive conditional heteroskedasticity (GARCH) model.

The loss risk processor 210 may be configured to scale the first and second deviations such that volatility of the first and second deviations matches a volatility forecast.

The margin requirement processor 212 may be configured to select a percentile of a distribution of the loss risk values for a long position for the financial product or for a short position for the financial product.

Each implied variance may be representative of global implied variance. The option trade data may include data representative of at-the-money (ATM) trades and out-of-the-money (OTM) trades. In an alternative embodiment, one or more types or instances of OTM trades may be excluded from the implied variance determination. For example, only the ATM trades may be used. Alternatively, excluded OTM trades may include those trades falling outside of a predetermined percentile-based or other range of, for instance, option spreads. The option trade receiver 206 may be configured to collect the option trade data over a look-back period that differs from a time period corresponding with the plurality of trading intervals.

The system 200 may include a margin adjustment processor in communication with the margin requirement processor 212 to, in response to an event in which the loss or risk exceeds the margin requirement, adjust the margin requirement based on the implied variance for the trading interval at which the event occurred. The margin adjustment processor may be integrated with the margin requirement processor 212 to any desired extent.

The financial product may be a variance futures product. Each trading interval may correspond with a trading day or any other time interval (week, month, hour, etc.). The trading intervals need not be continuous.

Referring to FIG. 2B, a system 300 is configured in accordance with one embodiment to determine a margin requirement for a financial product. The financial product is characterized by a risk of loss based on a market price that varies with volatility of a market value of an underlying instrument over a plurality of trading intervals. The system 300 includes a processor 302 and memory 304 coupled therewith. The system 300 further includes first logic 306 stored in the memory 304 and executable by the processor 302 to receive, subsequent to completion of each trading interval, return data representative of the market value for the trading interval. The system 300 includes second logic 308 stored in the memory 304 and executable by the processor 302 to determine a realized variance of the market value of the underlying instrument for each completed trading interval based on the return data. The system 300 includes third logic 310 stored in the memory 304 and executable by the processor 302 to receive option trade data indicative of prices for one or more option contracts for the underlying instrument. The system 300 includes fourth logic 312 stored in the memory 304 and executable by the processor 302 to calculate, for each completed trade interval, a respective implied variance of the financial product based on the option trade data, the respective implied variance being indicative of an expected variance of the market value of the underlying instrument for any remaining incomplete trading intervals of the plurality of trade intervals. The system 300 includes fifth logic 314 stored in the memory 304 and executable by the processor 302 to compute a respective loss risk value for each corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval. The system 300 includes sixth logic 316 stored in the memory 304 and executable by the processor 302 to determine the margin requirement based on a subset of the loss risk values.

The fifth logic 314 may be further executable to construct respective models of the first and second deviations over the completed trading intervals, determine first and second volatility forecasts for the first and second deviations based on the respective models, and scale each first deviation by the first volatility forecast and each second deviations by the second volatility forecast, respectively

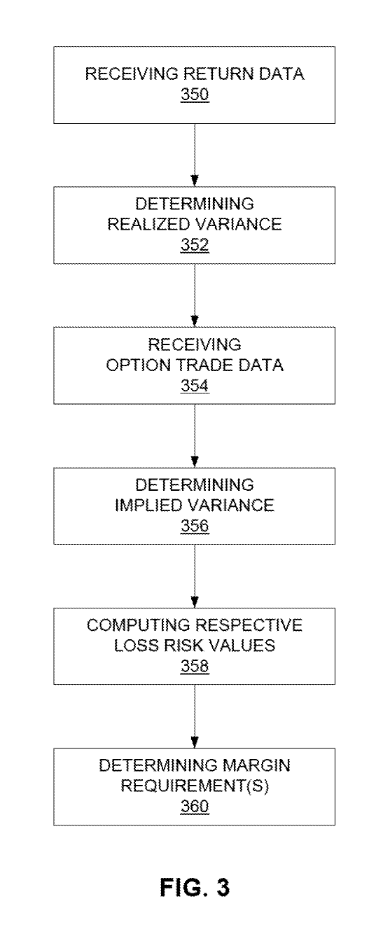

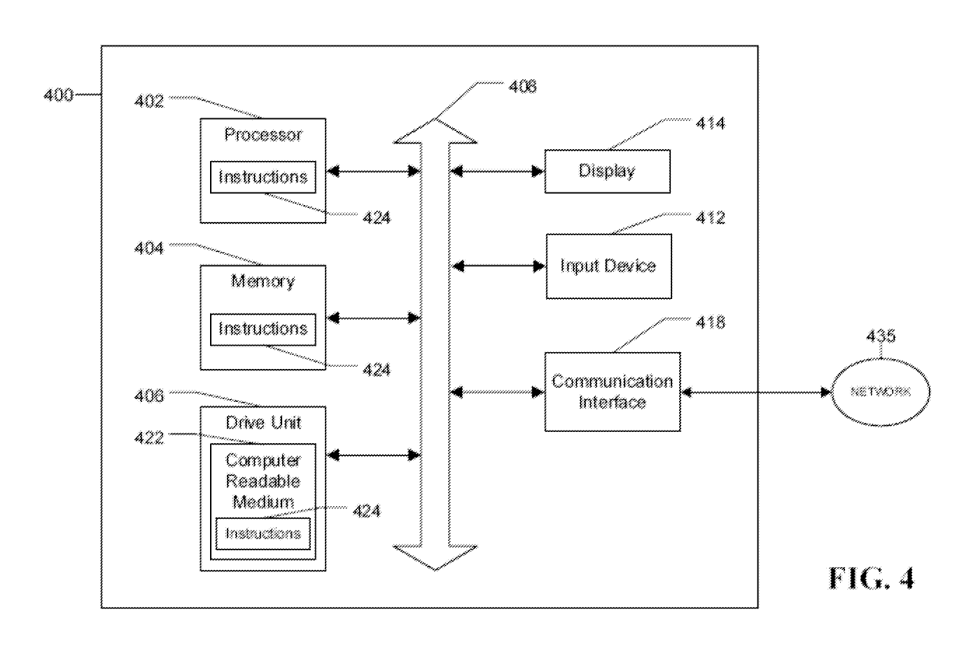

Referring to FIG. 3, a computer implemented method is configured in accordance with one embodiment to determine a margin requirement for a financial product. The financial product is characterized by a risk of loss based on a market price that varies with volatility of a market value of an underlying instrument over a plurality of trading intervals. The computer includes a processor, which may include multiple processing elements and, thus, processors. The computer implemented method may begin with the processor receiving (block 350), subsequent to completion of each trading interval, return data representative of the market value for the trading interval. The processor may then determine (block 352) a realized variance of the market value of the underlying instrument for each completed trading interval based on the return data. Either before or after implementation of the foregoing acts, the processor may receive (block 354) option trade data indicative of prices for one or more option contracts for the underlying instrument. For each completed trade interval, the processor may then calculate (block 356) a respective implied variance of the financial product based on the option trade data, the respective implied variance being indicative of an expected variance of the market value of the underlying instrument for any remaining incomplete trading intervals of the plurality of trade intervals. The processor may then compute (block 358) a respective loss risk value for each corresponding trading interval of the completed trading intervals. Each respective loss risk value may be derived from a first deviation between the realized variance of the corresponding trading interval and the implied variance of a preceding completed trading interval, and a second deviation between the implied variance of the corresponding trading interval and a succeeding completed trading interval. The processor may then determine (block 360) the margin requirement based on a subset of the loss risk values.

Computing the respective loss risk values may include constructing respective models of the first and second deviations over the completed trading intervals, determining first and second volatility forecasts for the first and second deviations based on the respective models, and scaling each first deviation by the first volatility forecast and each second deviations by the second volatility forecast, respectively. Scaling each first deviation and each second deviation may include dividing each first and second deviation by a corresponding volatility predicted by the respective model for the corresponding trading interval. Computing the respective loss risk values may include simulating each respective loss risk value by summing the scaled first and second deviations for the corresponding trading interval. Constructing the respective models may include fitting the first and second deviations to a generalized autoregressive conditional heteroskedasticity (GARCH) model.

Computing the respective loss risk values may include scaling the first and second deviations such that volatility of the first and second deviations matches a volatility forecast.

Determining the margin requirement may include selecting a percentile of a distribution of the loss risk values for a long position for the financial product or for a short position for the financial product. Alternatively or additionally, the determination may include other types of selections of subsets of the distribution. For example, a minimum/maximum technique may be implemented to determine the margin requirement.

Receiving the option trade data may include collecting the option trade data over a look-back period that differs from a time period corresponding with the plurality of trading intervals.

The computer implemented method may further include, in response to an event in which the loss or risk exceeds the margin requirement, adjusting, by the processor, the margin requirement based on the implied variance for the trading interval at which the event occurred.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400. The computer system 400 may implement a match engine on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Further details regarding constructing a time series of implied variance computing implied variance using market traded calls and puts is described below in connection with an exemplary embodiment. The method uses at-the-money (ATM) and out-of-the-money (OTM) option prices for each date considered in the back-test period. The implied variance is accordingly computed using a formula that takes into account the entire volatility skew, not simply the at-the-money options. The formula is provided below and as equation 26 in Derman, et al., “More Than You Ever Wanted to Know about Volatility Swaps,” Quantitative Strategies Research Notes, Goldman Sachs (1999), the entire disclosure of which is incorporated by reference. Nonetheless, the entire volatility skew need not be relied upon in other embodiments. Also, as described in the Derman paper, the weighting may be inversely proportional to the square of the strike price of the options. This is shown in the example below. Alternatively or additionally, the implied variance determination may be based on other historical data, such as historical variance or volatility data.

Example—Variance Futures Margin Requirement Determination.

Modeling the daily change in price of a variance future product in accordance with some embodiments of the disclosed methods and systems includes modeling multiple deviations or differences. In some examples, the deviations include (i) error of a one-day ahead forecast of variance and (ii) a day-to-day change in implied variance. The former model may quantify the difference between a determination of implied variance on day x (e.g., today) and a realized variance on day x+1 (e.g., tomorrow) to gauge the market's predictive power. The latter model may quantify daily differences between implied variance itself. In other words, the disclosed methods and systems may be configured to quantify the change in the market's expectation in an attempt to model “vol-vol” (volatility of volatility). Once a time series of these deviations or differences is constructed, one example of the disclosed methods and systems includes fitting a GARCH (1,1) model to each series to compute the one-day ahead forecasted volatility. GARCH (generalized autoregressive conditional heteroskedasticity) is a tool that allows one to use historical data to compute forecasts of volatility. Other forecast models or tools may be used (e.g., EWMA). Such forecasting tools allow one to model properties of a time series observed in practice. The two time series are taken, and scaled by the ratio of GARCH predicted volatility/realized volatility until that point. Realized volatility is always up to a point in time. Therefore, this ratio gives one an idea of the size of the jump in volatility.

The method may conclude by computing the margin for a long/short position by taking a percentile, e.g. 99%, over some look-back period. The margin may then be smoothed.

The disclosed methods may be applied to a Standard & Poor's (S&P) Variance Future with a 20 trading-day period, maturing in 15 trading days. In this example, the following realized log returns have already accrued for the first five days:

| Day | Return |
|---|---|
| 1 | −2.29% |
| 2 | −1.01% |
| 3 | 0.13% |
| 4 | 0.90% |
| 5 | 1.57% |

To calculate the realized accrued variance, the above numbers are multiplied by 100, squared, and summed. The realized variance to date is 9.56. With the spot price at 1200, the following options trade data is collected from the market:

| Put/Call | Strike | Value |
|---|---|---|
| Put | 900 | 0.0007 |
| Put | 1050 | 0.3448 |
| Put | 1175 | 12.7323 |
| Call | 1200 | 23.3574 |
| Call | 1325 | 0.6532 |
| Call | 1400 | 0.0415 |

One embodiment of the disclosed methods is configured to attempt to determine an accurate representation of the implied variance by not simply using the at-the-money implied volatility. In this example, the disclosed method determines the future variance based on information indicative of out-of-the-money options. The implied volatility of a single option reflects the expectation of the market of realized volatility for returns that occur when the spot price is close to the strike. In this example, the global implied variance is computed. As shown in Derman et al (1999), the solution to this is to use integration (assuming zero interest rates for simplicity):

$$Market Implied Global Variance = \text{10,000} \times \frac{2}{T} ( - ( \frac{{S}_{0}}{{S}_{*}} - 1 ) - log ( \frac{{S}_{*}}{{S}_{0}} ) + {\int }_{0}^{{S}_{*}} ( \frac{1}{{K}^{2}} ) P ( k ) d K + {\int }_{{S}_{*}}^{∞} ( \frac{1}{{K}^{2}} ) C ( K ) d K )$$

Where T is the time to maturity of the options

$$( in this case = \frac{15}{252} ) ,$$

S₀ is the spot price, and S_{*} is the price dividing the use of put values from call values. In one example, S_{*}=1200 because only call data is present for strike prices of 1200 and above in this example. K indicates strike price, and P(K) and C(K) indicate put and call values at strike K.

The foregoing equation may be solved or implemented via one or more numerical integration functions of a commercially available or other computational processor. For example, the numerical integration function provided by MATLAB may be used. In this example, the result is that Market Implied Global Variance equals 1430. This means that the market's global volatility estimate is \sqrt{1430}=37.82. So the market prices the variance futures as something like

$$Variance Futures Price ( Day 5 ) = \frac{252}{20} ( 9.56 + \frac{15}{252} 1430 ) = 1193$$

In practice, the market price is usually a little different from the theoretical price because of slippage and other market imperfections. Suppose now that on day 6 the realized return is −3%, and the implied variance goes to 1500. Then the new price is:

$$Variance Futures Price ( Day 6 ) = \frac{252}{20} ( 18.56 + \frac{14}{252} 1500 ) = 1284$$

A long position gains (1284−1193)×50=$4,545. This change can be decomposed according to the previous profit-and-loss (P&L) or loss risk equation:

| P&L Source | Calculation | Value |
|---|---|---|
| Realized > 1430 | (252/20) × (3\hat{ }2 − 1430/252) = | 41.90 |
| Implied | (252/20) × (9 − 5.67) = | |
| Change in Implied | (252/20) × (14/252) × (1500 − | 49.00 |
| Variance | 1430) = (14/20) × 70 = | |
| Total P&L | 50 × (41.90 + 49) = | $4,545 |

Thus, the two sources of P&L are how tomorrow's realized squared return differs from today's implied variance (3̂2−1403/252), and how tomorrow's implied variance differs from today's (14/252)×(1500−1403). Both of these sources may be modeled using GARCH(1,1) volatility estimates. The GARCH(1,1) model is one of multiple suitable for use with and/or incorporation into the disclosed methods and systems as forward-looking models or measures of determining tomorrow's expected standard deviation for a variable, such as the time series involved in the disclosed methods.

At the end of day 6, a margin is calculated based on the following realizations of P&L components, and their corresponding GARCH(1,1) volatilities, for the previous 6 days:

| | Realized − | GARCH(1,1) | Change in | GARCH(1,1) |
|---|---|---|---|---|
| Day | Implied/252 | Volatility | Implied | Volatility |
| 1 | 1.78 | 1.6 | 50 | 41 |
| 2 | 1.20 | 2.00 | −25 | 40 |
| 3 | 0.50 | 1.75 | 93 | 38 |
| 4 | −2.05 | 1.00 | 28 | 42 |
| 5 | −0.95 | 1.25 | −70 | 36 |
| 6 | 3.43 | 1.10 | 70 | 39 |
| 7 | N/A | 2.2 | — | 45 |

For each of the previous days, the component is rescaled so that its volatility matches the volatility forecasts for tomorrow. So each component is divided by its own GARCH (1,1) volatility, and multiplied by the forecast for tomorrow's volatility. So the rescaled data becomes:

| | Realized − | Change in |
|---|---|---|
| | Implied/252 | Implied |
| Day | (Scaled) | (Scaled) |
| 1 | 2.4 | 55 |
| 2 | 1.3 | −28 |
| 3 | 0.6 | 110 |
| 4 | −4.5 | 30 |
| 5 | −1.7 | −88 |
| 6 | 6.9 | 81 |

By the end of day 7, there are 13 more days until maturity, and one more day of realized. Using this fact, the P&L is simulated with the table above by setting:

$$Simulated P \& L = ( \frac{252}{20} ) ( Realized - \frac{Implied}{252} ( Scaled ) - ( \frac{13}{252} ) Change in Implied ( Scaled ) )$$

The P&L results (or loss risk values) determined by the method are thus:

| Day | Simulated |
|---|---|
| (Simulation) | P&L |
| 1 | 66 |
| 2 | −2 |
| 3 | 79 |
| 4 | −37 |
| 5 | −78 |
| 6 | 140 |

In this example, the margin requirements are determined based on a subset of the above distribution. The subset may include some or all of the risk loss values in the distribution. In one case, the subset may correspond with the 99th percentile to determine the margin for a short position, and a 1^{st} percentile to determine the margin for the long. Percentile-based techniques need not be used to determine the subset. In some cases, the margin may be determined via a computation or other technique rather than, or in addition to, selection of a subset of the distribution.

Because there are only six samples (there may be many more samples), this determination is the same as using the best and worst simulation, respectively. So for a long position, the worst simulated loss is 78, corresponding to day 5, and for a short position, the worst is 140, corresponding to day 6. These are the long and short margins respectively.

The disclosed methods and systems may model the change in fair variance strike, or global implied variance, which is what drives the prices of variance futures contracts. Because fair variance strike is forward looking as described below, the disclosed methods and systems may provide some predictive power. The disclosed methods and systems may also, as a result, model the replication cost of variance swaps.

Example Results.

Even in the most volatile periods (e.g., Q4 2008), the margins determined by the disclosed methods on the short-variance side never exceeded 93% of contract value. Long-variance margins never exceeded 50% of contract value in the entire test period. On average, margins were 22.96% of contract value for a long-variance trade, and 35.52% for a short-variance trade. For instance, given a 1000 variance futures level, long margins were about 230 points, and short margins were about 350 points. With a contract multiplier of 50, that means total contract value was $50,000 and dollar margins were $11,500 and $17,500, respectively.

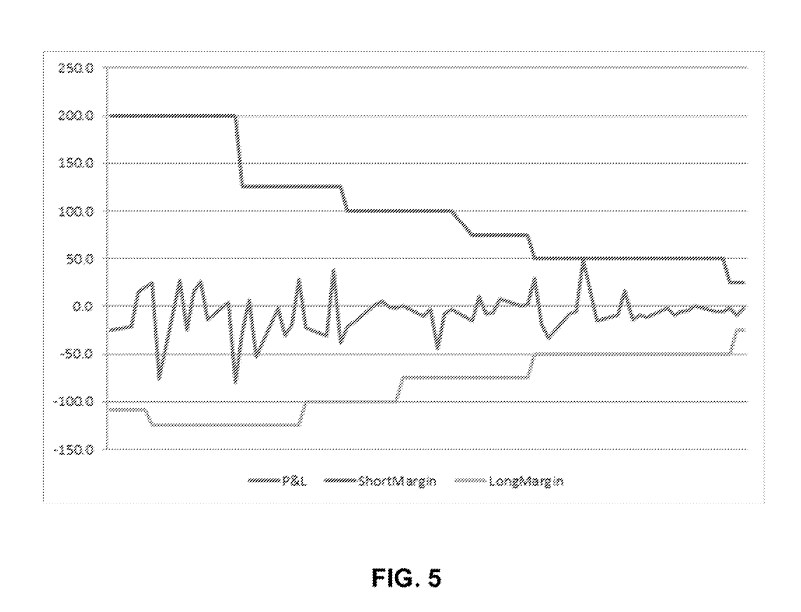

FIG. 5 is a graphical plot depicting margin requirements resulting from implementing the above-described example of the disclosed method, where, for a variance futures contract accruing realized variance from Sep. 17, 2010, to Dec. 17, 2010, and a futures level on 580.5, the long-variance margin was 125 points, and the short-variance margin was 200 points.

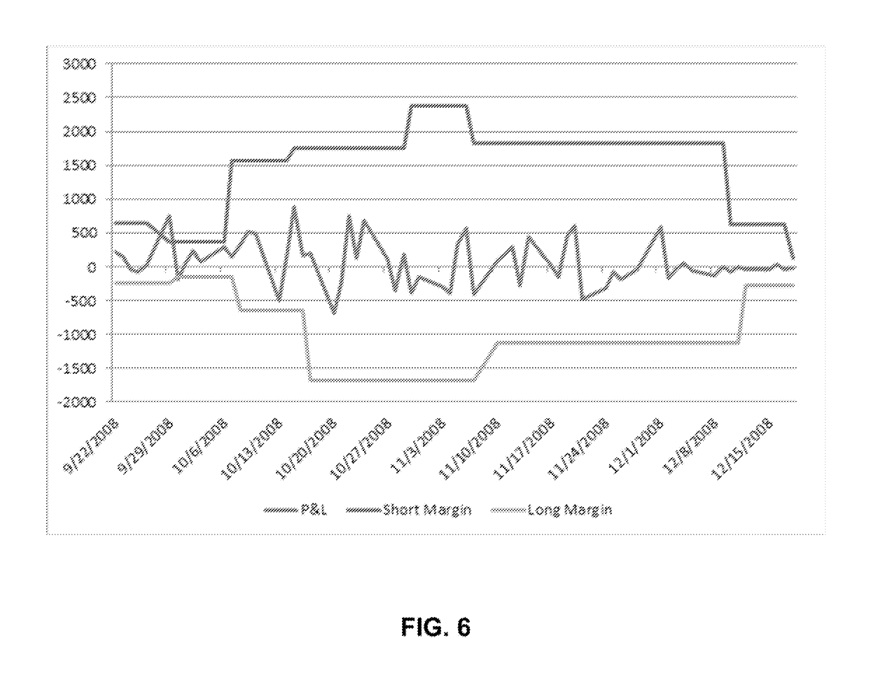

FIG. 6 is a graphical plot depicting margin requirements resulting from implementing the above-described example of the disclosed method, where, for a December 2008 contract, the highest short-variance margin over this period was 2375 points, but during which time (Oct. 30, 2008 to Nov. 6, 2008), the average absolute value of daily change in value was over 350 points, and the futures price was on average 4500, so the margin was only roughly 50% of contract value.

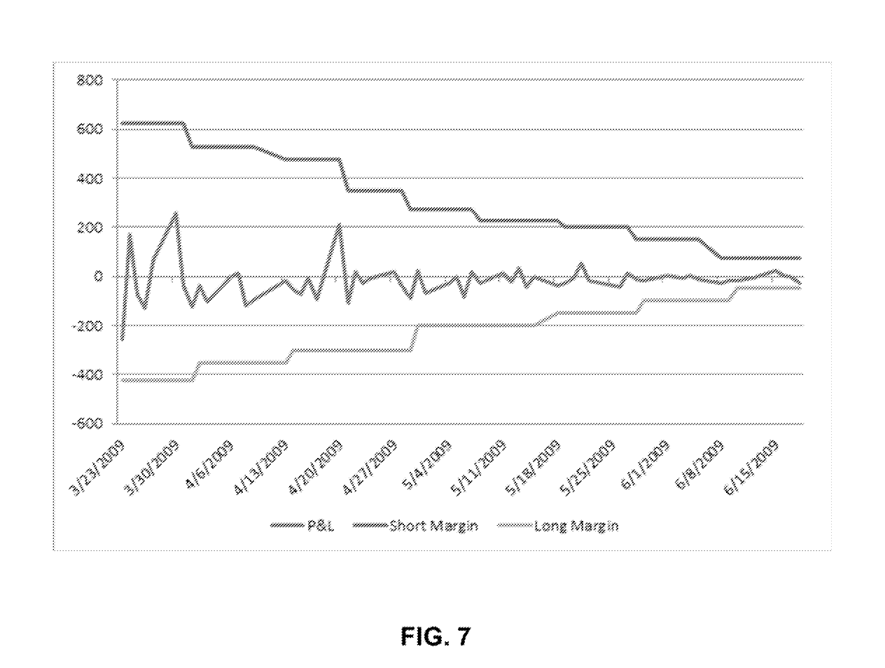

FIG. 7 depicts the change in margin requirements as a result of implementing the above-described example of the disclosed methods. As n approaches N (i.e., as the contract expiration approaches), the second change in value component goes to zero,

$$\frac{N - ( n + 1 )}{252} ( K ( {t}_{n + 1} , {T}_{N} ) - K ( {t}_{n} , {T}_{N} ) ) \to 0$$

so the margins should shrink over time as well. As one gets closer to expiry, the margins decrease because the margin is increasingly driven by realized variance and implied variance has less impact.

In view of the declining margins, to keep total variance sensitivity constant, a trader may increase his contract holdings linearly as expiration nears, meaning the total dollar margin for the trader would remain constant over time, but the margin per contract would decline.

The disclosed methods were also implemented on S&P Variance Futures products listed by the CBOE. For fitting the GARCH(1,1) parameters, a look-back period of 124 trading days (approximately half a year) is used, and for estimating the percentiles a look-back of 62 trading trades (roughly one quarter) is used. Running the model on the variance futures listed from December 2008 to March 2011, coverage of well over 99% coverage is achieved. The following table demonstrates the coverage of the resulting margin requirements:

| | | |
|---|---|---|
| Total Violations | 2 | 2 |
| Total Observations | 549 | 549 |
| % Coverage | 99.64% | 99.64% |

Exemplary Model Quantification.

The above-described embodiments model variance futures as discrete time instruments. This approach to modeling the futures may benefit from the linear nature of the pay-off (e.g., in realized daily variance) of variance futures. Nonetheless, alternative embodiments may model variance futures in continuous time, e.g., as a continuous-time variance.

In a discrete-time model, a variance future that begins on day 0 and expires on day N has a price on day N of

$$V ( N , N ) = \frac{252}{N} {\sum }_{i = 1}^{N} {( log \frac{{s}_{i}}{{s}_{i - 1}} )}^{2}$$

Therefore, on some trading day n<N,

$$V ( n , N ) = E [ \frac{252}{N} {\sum }_{i = 1}^{N} {( log \frac{{s}_{i}}{{s}_{i - 1}} )}^{2} \vert {F}_{n} ] = \frac{252}{N} ( {\sum }_{i = 1}^{N} {( log \frac{{s}_{i}}{{s}_{i - 1}} )}^{2} + Ei = n + 1 MogSiSi - 12 Fn \\ V ( n , N ) = \frac{252}{N} ( {\sum }_{i = 1}^{n} {( log \frac{{S}_{i}}{{S}_{i - 1}} )}^{2} + \frac{N - ( n + 1 )}{252} K ( {t}_{n} , {T}_{N} ) )$$

where K (tₙ, T_{N}) is a fair variance strike (or global implied volatility) for a variance future starting at time tₙ (i.e, trading day n re-expressed as continuous time), and expiring at time T_{N}. Letting ΔV(n, n+1)=V(n+1, N)−V(n, N), it can be shown that:

$$Δ V ( n , n + 1 ) = \frac{252}{N} ( {( log \frac{{S}_{N + 1}}{{S}_{n}} )}^{2} - \frac{K ( {t}_{n} , {T}_{N} )}{252} + \frac{N - ( n + 1 )}{252} ( K ( {t}_{n + 1} , {T}_{N} ) - K ( {t}_{n} , {T}_{N} ) ) )$$

i.e., the change in the variance futures is attributable to 1) the error in the one-day-ahead forecasted variance

$${( log \frac{{s}_{n + 1}}{{s}_{n}} )}^{2} - \frac{K ( {t}_{n} , {T}_{N} )}{252} , and 2 )$$

the change in the fair variance strike

$$\frac{N - ( n + 1 )}{252} ( K ( {t}_{n + 1} , {T}_{N} ) - K ( {t}_{n} , {T}_{N} ) ) .$$

The margin models of the disclosed methods and systems may address these changes separately, fitting GARCH(1,1) models to both. Alternatively, the disclosed methods and system may address the changes in an integrated or otherwise combined manner. The margin is forecast one day ahead on day n. Let

$$X ( k ) = {( log \frac{{s}_{k + 1}}{{s}_{k}} )}^{2} - \frac{K ( {t}_{n} , {T}_{N} )}{252} ,$$

kε(1, 2, . . . , n) (i.e. the realized variance forecast errors up to day n). The GARCH(1,1) model provides a one-step-ahead predicted volatility of X, σₓ (n+1). In addition, the GARCH(1,1) volatilities σₓ(k), kε(1, 2, . . . n) are determined. To calculate margins, X is re-scaled to be

$$\tilde{X} ( k ) = \frac{{σ}_{x ( n + 1 )}}{{σ}_{x} ( k )} X ( k ) .$$

Similarly, the following determination is made: Y(k)=K(tₖ₊₁, T_{N})−K(tₖ, T_{N}) and a GARCH(1,1) fit is implemented on this data. Then the data is re-scaled so that

$$\tilde{Y} ( k ) = \frac{{σ}_{x ( n + 1 )}}{{σ}_{x} ( k )} Y ( k ) .$$

A new time series consistent is created with the current trading day n:

$$Z = \frac{252}{N} ( \tilde{X} ( k ) + \frac{N - ( n + 1 )}{252} \tilde{Y} ( k ) )$$

In these ways, in some embodiments, a historical value at risk may be scaled with GARCH(1,1) volatility. For a long position, an initial estimated margin is created as M_{Long}=Perc(Z, 0.01). And for a short position, the initial estimated margin is M_{Short}=Perc(Z, 0.99), where Perc(ν, α) is the empirical α^{th} percentile of the random variable ν.

Given the high positive skewness of variance, these margins are not symmetric generally speaking Asymmetric margins are generally desirable, because empirically the risk to a short realized variance position is very heavy-tailed, while the opposite is true of a long position (that is, volatility tends to have large upward spikes, but almost never has large downward spikes).

In some embodiments, to smooth the margins, the margins are rounded up in magnitude to the nearest multiple of 25. Logic may alternatively or additionally be incorporated so that the quoted margins only increase (decrease) to a new margin level if the new margin estimate is higher (lower) than the currently posted margin for 5 trading days. This may prevent the model from following temporary margin spikes that might actually increase the traded contract's volatility by surprising the market with frequent jumps in margin requirements.

However, if there is a violation on either the short or long side, in some embodiments, an adjusted margin may be computed to reflect the jump in market implied global variance. Once the adjusted margin is calculated, it may remain at that level, for example, for the next 5 days unless there is another violation or profit and loss values warrant a change in margin. From that point onward, the method may be implemented as described above.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

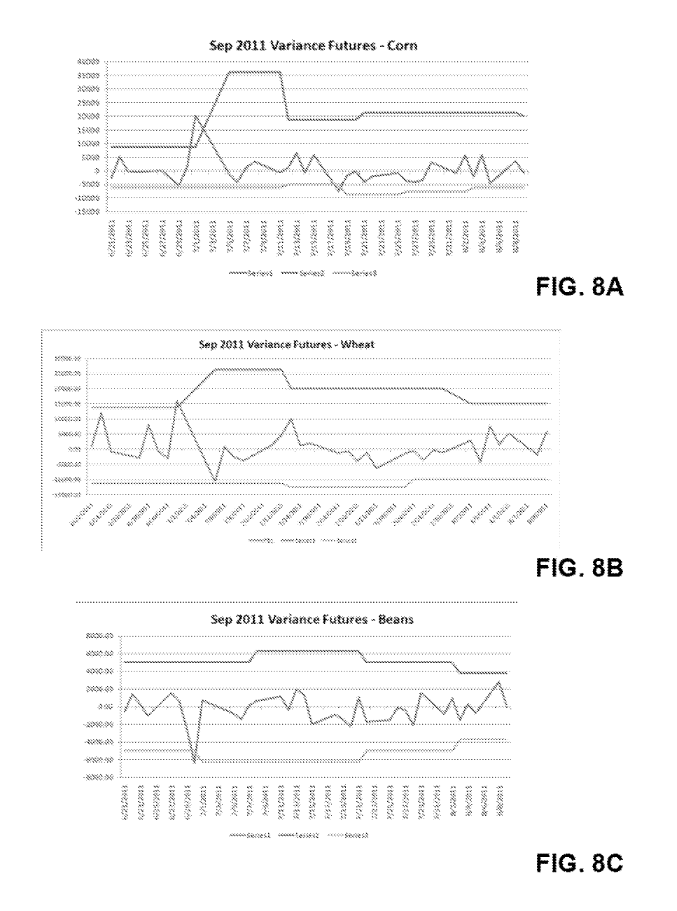

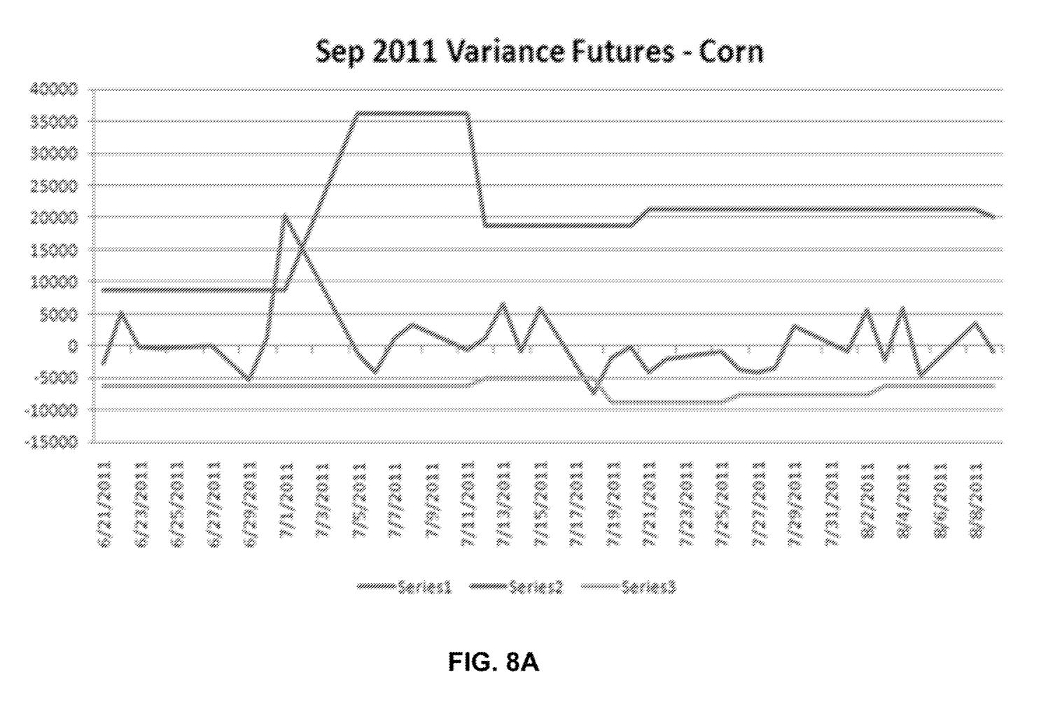

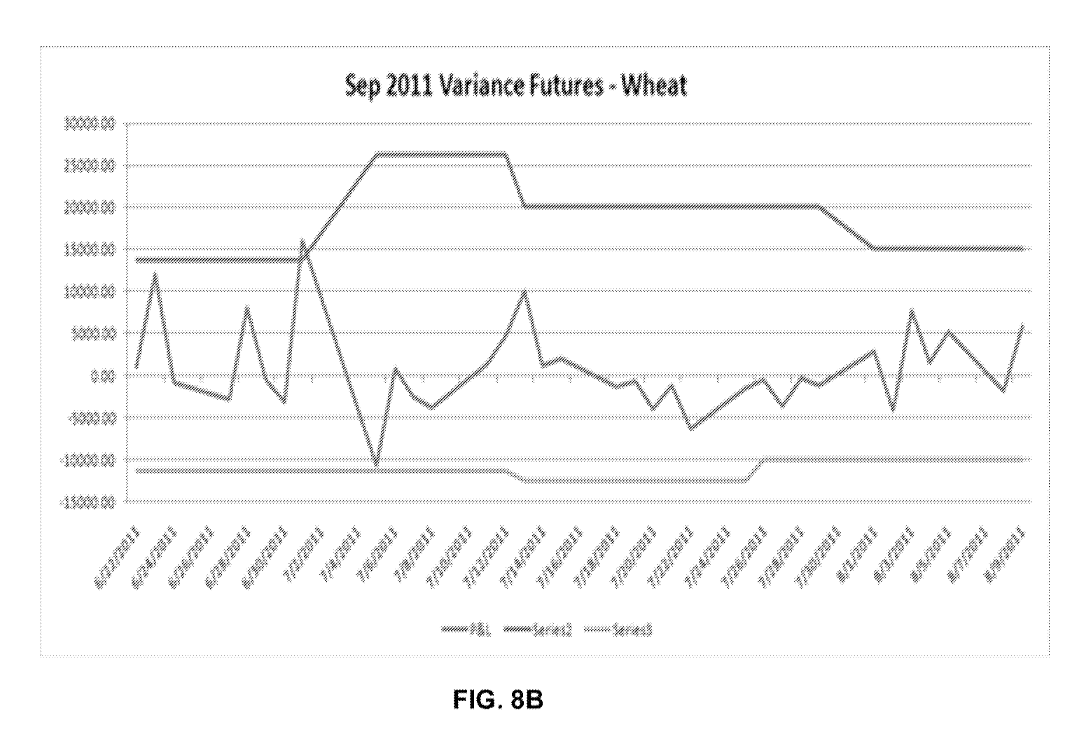

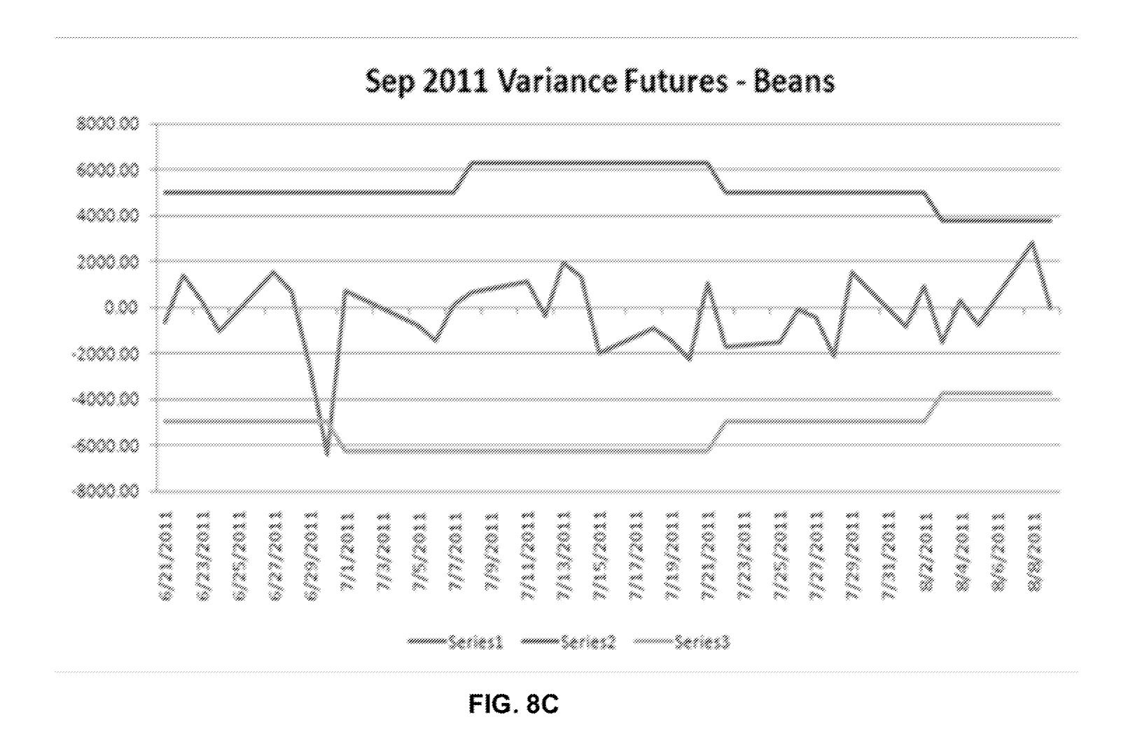

FIGS. 8A-8C are graphical plots depicting margins determined via one example of the disclosed methods for the September 2011 corn, wheat, and soybean contracts, respectively. FIG. 8A shows the corn contract, of which the futures value was $77,182. The long margin ended at $6,250 (8% of value), and the short margin ended at $20,000 (26% of value). The average short margin between 6/20 and 8/9 was $19,642 (26% of average value), and the average long margin between 6/20 and 8/9 was $6,642 (8% of average value).

FIG. 8B shows the wheat contract, of which the futures value was $90,971. The long margin ended at $10,000 (11% of value), and the short margin ended at $15,000 (16% of value). The average short margin between 6/20 to 8/9 was $18,500 (23% of average value), and the average long margin between 6/20 to 8/9: was $11,142 (14% of average value).

FIG. 8C shows the soybeans contract, of which the futures value was $14,061. The long margin ended at $3750 (27% of value), and the short margin ended at $3750 (27% of value). The long and short margins ended at the same level due to rounding. Such symmetry may not be exhibited in connection with other underlying products. The average short margin between 6/20 to 8/9 was $5,178 (27% of average value), and the average long margin between 6/20 to 8/9 was $5,321 (28% of average value).

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for determining a margin requirement for a financial product, the financial product being characterized by a risk of loss based on a market price that varies with volatility of a market value of an underlying instrument over a plurality of trading intervals, the computer comprising a processor, the computer implemented method comprising:
receiving, by the processor, subsequent to completion of each trading interval, return data representative of the market value for the trading interval;
determining, by the processor, a realized variance of the market value of the underlying instrument for each completed trading interval based on the return data;
receiving, by the processor, option trade data indicative of prices for one or more option contracts for the underlying instrument;
for each completed trade interval, calculating, by the processor, a respective implied variance of the financial product based on the option trade data, the respective implied variance being indicative of an expected variance of the market value of the underlying instrument for any remaining incomplete trading intervals of the plurality of trade intervals;
computing, by the processor, a respective loss risk value for each corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval; and
determining, by the processor, the margin requirement based on a subset of the loss risk values.

2. The computer implemented method of claim 1 wherein computing the respective loss risk values comprises:
constructing respective models of the first and second deviations over the completed trading intervals;
determining first and second volatility forecasts for the first and second deviations based on the respective models; and
scaling each first deviation by the first volatility forecast and each second deviations by the second volatility forecast, respectively.

3. The computer implemented method of claim 2 wherein scaling each first deviation and each second deviation comprises dividing each first and second deviation by a corresponding volatility predicted by the respective model for the corresponding trading interval.

4. The computer implemented method of claim 2 wherein computing the respective loss risk values comprises simulating each respective loss risk value by summing the scaled first and second deviations for the corresponding trading interval.

5. The computer implemented method of claim 2 wherein constructing the respective models comprises fitting the first and second deviations to a generalized autoregressive conditional heteroskedasticity (GARCH) model.

6. The computer implemented method of claim 1 wherein computing the respective loss risk values comprises scaling the first and second deviations such that volatility of the first and second deviations matches a volatility forecast.

7. The computer implemented method of claim 1 wherein determining the margin requirement comprises selecting a percentile of a distribution of the loss risk values for a long position for the financial product or for a short position for the financial product.

8. The computer implemented method of claim 1 wherein each implied variance is representative of global implied variance.

9. The computer implemented method of claim 1 wherein the option trade data comprises data representative of at-the-money (ATM) trades and out-of-the-money (OTM) trades.

10. The computer implemented method of claim 1 wherein receiving the option trade data comprises collecting the option trade data over a look-back period that differs from a time period corresponding with the plurality of trading intervals.

11. The computer implemented method of claim 1 further comprising, in response to an event in which the loss or risk exceeds the margin requirement, adjusting, by the processor, the margin requirement based on the implied variance for the trading interval at which the event occurred.

12. The computer implemented method of claim 1 wherein the financial product is a variance futures product.

13. The computer implemented method of claim 1 wherein each trading interval corresponds with a trading day.

14. A system for determining a margin requirement for a financial product, the financial product being characterized by a risk of loss based on a market price that varies with volatility of a market value of an underlying instrument over a plurality of trading intervals, the system comprising:
a price return receiver operative to receive, subsequent to completion of each trading interval, return data representative of the market value for the trading interval;
a realized variance processor in communication with the price return receiver and operative to determine a realized variance of the market value of the underlying instrument for each completed trading interval based on the return data;
an option trade receiver operative to receive option trade data indicative of prices for one or more option contracts for the underlying instrument;
an implied variance processor in communication with the option trade receiver and operative to calculate, for each completed trade interval, a respective implied variance of the financial product based on the option trade data, the respective implied variance being indicative of an expected variance of the market value of the underlying instrument for any remaining incomplete trading intervals of the plurality of trade intervals;
a loss risk processor in communication with the realized variance processor and the implied variance processor, the loss risk processor being operative to compute a respective loss risk value for each corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval; and
a margin requirement processor in communication with the loss risk processor and operative to determine the margin requirement based on a subset of the loss risk values.

15. The system of claim 14 wherein the loss risk processor is configured to construct respective models of the first and second deviations over the completed trading intervals, determine first and second volatility forecasts for the first and second deviations based on the respective models, and scale each first deviation by the first volatility forecast and each second deviations by the second volatility forecast, respectively.

16. The system of claim 15 wherein the loss risk processor is further configured to divide each first and second deviation by a corresponding volatility predicted by the respective model for the corresponding trading interval.

17. The system of claim 15 wherein the loss risk processor is configured to simulate each respective loss risk value by summing the scaled first and second deviations for the corresponding trading interval.

18. The system of claim 15 wherein the loss risk processor is configured to fit the first and second deviations to a generalized autoregressive conditional heteroskedasticity (GARCH) model.

19. The system of claim 14 wherein the loss risk processor is configured to scale the first and second deviations such that volatility of the first and second deviations matches a volatility forecast.

20. The system of claim 14 wherein the margin requirement processor is configured to select a percentile of a distribution of the loss risk values for a long position for the financial product or for a short position for the financial product.

21. The system of claim 14 wherein each implied variance is representative of global implied variance.

22. The system of claim 14 wherein the option trade data comprises data representative of at-the-money (ATM) trades and out-of-the-money (OTM) trades.

23. The system of claim 14 wherein the option trade receiver is configured to collect the option trade data over a look-back period that differs from a time period corresponding with the plurality of trading intervals.

24. The system of claim 14 further comprising a margin adjustment processor in communication with the margin requirement processor to, in response to an event in which the loss or risk exceeds the margin requirement, adjust the margin requirement based on the implied variance for the trading interval at which the event occurred.

25. The system of claim 14 wherein the financial product is a variance futures product.

26. The system of claim 14 wherein each trading interval corresponds with a trading day.

27. A system for determining a margin requirement for a financial product, the financial product being characterized by a risk of loss based on a market price that varies with volatility of a market value of an underlying instrument over a plurality of trading intervals, the system comprising a processor and memory coupled therewith, the system further comprising:
first logic stored in the memory and executable by the processor to receive, subsequent to completion of each trading interval, return data representative of the market value for the trading interval;
second logic stored in the memory and executable by the processor to determine a realized variance of the market value of the underlying instrument for each completed trading interval based on the return data;
third logic stored in the memory and executable by the processor to receive option trade data indicative of prices for one or more option contracts for the underlying instrument;
fourth logic stored in the memory and executable by the processor to calculate, for each completed trade interval, a respective implied variance of the financial product based on the option trade data, the respective implied variance being indicative of an expected variance of the market value of the underlying instrument for any remaining incomplete trading intervals of the plurality of trade intervals;
fifth logic stored in the memory and executable by the processor to compute a respective loss risk value for each corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval; and
sixth logic stored in the memory and executable by the processor to determine the margin requirement based on a subset of the loss risk values.

28. The system of claim 27 wherein the fifth logic is further executable to construct respective models of the first and second deviations over the completed trading intervals, determine first and second volatility forecasts for the first and second deviations based on the respective models, and scale each first deviation by the first volatility forecast and each second deviations by the second volatility forecast, respectively.

29. A system for determining a margin requirement for a financial product, the financial product being characterized by a risk of loss based on a market price that varies with volatility of a market value of an underlying instrument over a plurality of trading intervals, the system comprising:
means for receiving, subsequent to completion of each trading interval, return data representative of the market value for the trading interval;
means for determining a realized variance of the market value of the underlying instrument for each completed trading interval based on the return data;
means for receiving option trade data indicative of prices for one or more option contracts for the underlying instrument;
means for calculating, for each completed trade interval, a respective implied variance of the financial product based on the option trade data, the respective implied variance being indicative of an expected variance of the market value of the underlying instrument for any remaining incomplete trading intervals of the plurality of trade intervals;
means for computing a respective loss risk value for each corresponding trading interval of the completed trading intervals, each respective loss risk value being derived from a first deviation between the realized variance of the corresponding trading interval and the implied variance of a preceding completed trading interval, and a second deviation between the implied variance of the corresponding trading interval and a succeeding completed trading interval; and
means for determining the margin requirement based on a subset of the loss risk values.

30. The system of claim 29 wherein the computing means further comprises means for scaling the first and second deviations such that volatility of the first and second deviations matches a volatility forecast.
